(19) United States
(12) Patent Application Publication
(10) Pub. No.: US 2014/0373507 A1
(43) Pub. Date: Dec. 25, 2014

(54) ROCKET ENGINE WITH OPTIMIZED FUEL SUPPLY

(71) Applicant: SNECMA, Paris (FR)

(72) Inventors: Nicolas Soulier, Fontaine Bellenger (FR); David Hayoun, Paris (FR); Jean Michel Sannino, Saint-Marcel (FR)

(73) Assignee: SNECMA, Paris (FR)

(21) Appl. No.: 14/372,883

(22) PCT Filed: Jan. 16, 2013
(86) PCT No.: PCT/FR2013/050094

§ 371 Date: Jul. 17, 2014

(30) Foreign Application Priority Data
Jan. 17, 2012 (FR) 1250460

(51) Int. Cl. F02K 9/46

(52) U.S. Cl. CPC F02K 9/46
USPC 60/246

(57) ABSTRACT

A rocket engine comprises a prechamber and a combustion chamber, two respective feed pipes of the engine, and two turbopumps. The engine is a staged combustion engine. A jet pump is arranged in at least a first feed pipe. After being pressurized, a portion of the fluid flowing in the first feed pipe is directed to the jet pump in order to enable the jet pump to entrain the fluid flowing in said feed pipe to the admission orifice of said first pump, thereby raising the pressure at the feed orifice of the pump.

The invention relates to a rocket engine having:
a combustion prechamber;
a main combustion chamber;
two feed pipes for feeding the engine respectively with fuel and with oxidizer; and
two turbopumps, each having a pump associated with a turbine, said pumps being arranged at respective downstream ends of the feed pipes and being suitable for pumping the fuel and the oxidizer from the feed pumps to the main combustion chamber via a fluid distribution circuit;

the distribution circuit being suitable for directing at least a portion of the fuel and of the oxidizer to the prechamber in order to be burnt therein, and for directing the hot gas as produced in that way from the prechamber to the combustion chamber while driving at least one turbine of the turbopump.

Such an engine is said to be a “staged combustion engine”. The invention proposes an improvement in the fuel or oxidizer feed circuit of an engine of this type.

Making such an engine requires provision to be made for injecting hot gas from the turbines into an injection head incorporated in the main combustion chamber. For this injection of hot gas, it is preferable to implant the feed pumps of the engine so that their pumps are towards the bottom and their turbines towards the top in order to minimize the length of the circuit for reinjecting hot gas (from the outlet of the turbines to the injection head).

However, that configuration involves feed pipes that include bends upstream from the pumps. Unfortunately, such bends lead to head losses in the feed pipes, which head losses are detrimental to good operation of the pumps during stages in which the engine is in operation. Therefore, in order to maintain nevertheless a sufficient pressure at the admission orifices of the pumps while the engine is in operation, it is common practice to fit the fuel or oxidizer feed circuit with a booster pump that is arranged in the feed pipe or between the feed pipe and the fuel or oxidizer tank.

Nevertheless, that solution presents the drawback of adding an additional component in the engine, namely the booster pumps and their feed systems: this leads to extra complexity, cost, and weight.

Various rocket engines with a prechamber are also disclosed in Document US 2001/0015063. In order to simplify the design of such engines, that document teaches arranging the gas distribution circuit in such a manner that the combustion gas coming from the prechamber is injected into one of the main pipes.

Nevertheless, that embodiment leads to injecting gas that is extremely hot compared with the fuel or oxidizer flowing in the main pipe. Such injection exposes components that are downstream from the injection point in the main pipe to enormous temperature differences and stresses; furthermore, under such conditions, it is difficult to ensure that the engine operates stably.

Another known solution for ensuring sufficient pressure at the admission orifices of the pumps consists in raising the pressure in the fuel and/or oxidizer tanks. Nevertheless, that solution also gives rise to an increase in complexity and in particular of weight due to the increase required in the thickness of the walls of the tank.

The object of the invention is to propose an engine of the type presented in the introduction in which the head losses generated by the bends in the feed pipes of the engine are compensated, at least in part, so as to maintain sufficient pressure at the admission orifices of the pumps, and to do so without using an additional turbomachine such as a booster pump, in order to reduce the cost and the weight of the propulsion assembly.

This object is achieved by the facts that in the engine, a jet pump is arranged in at least a first feed pipe feeding a first of said pumps, and that the distribution circuit is suitable for directing to the jet pump a portion of the fluid that is flowing in said first feed pipe and that has been put under pressure, and the jet pump is suitable for injecting said portion of fluid in such a manner as to entrain the fluid flowing in said first feed pipe towards an admission orifice of said first pump. Under the effect of this drive, the pressure in the first feed pipe upstream from the admission orifice of the first pump is increased. This increase in pressure serves to maintain a relatively high pressure at the admission orifice of said first pump and reduces or even eliminates cavitation therein.

The term “portion of the fluid that is flowing in said feed pipe and that has been put under pressure” designates a stream of fluid taken from the first feed pipe and raised to a pressure that is considerably higher than that of the feed pipe, for example a pressure that is at least 100 bar higher than the pressure in the feed pipe.

This fluid stream may be put under pressure either in the first main pipe, prior to being extracted therefrom: in general it is then put under pressure by the above-mentioned first pump. Alternatively, this fluid stream may be put under pressure after being taken from the main pipe, e.g. by a pressure booster.

Preferably, the jet pump injects only said fluid portion into the first feed pipe (i.e. the fluid portion is injected on its own, without being mixed with other fluids). The fluid portion may in particular be taken from the first main pipe via a takeoff pipe and then put under pressure.

Consequently, the fluid stream injected by the jet pump is of the same composition as the fluid flowing in the first main pipe.

As a result the fluid injected by the jet pump does not change the chemical composition of the fluid flowing in the first main pipe. Consequently, this injection of fluid advantageously runs no risk of degrading the quality of combustion in the main combustion chamber by giving rise to undesirable variations in the stoichiometry of the substances injected into that chamber.

Preferably, the distribution circuit is arranged in such a manner that the fluid injected by the jet pump does not include combustion gas, e.g. coming from the prechamber or from some other combustion. Thus, the temperature of the fluid injected by the jet pump is close to the temperature of the fluid in the first main pipe at the point where fluid is injected by the jet pump (i.e. the temperature difference remains less than 50 K or 100 K). By means of this, the injection of fluid by the jet pump does not give rise to temperature variations that might lead to harmful temperature stresses in the engine, even if that injection takes place in irregular or non-constant manner.

The distribution circuit is preferably arranged in such a manner that the fluid injected by the jet pump is in the liquid phase, as is the fluid flowing in the first feed pipe at the point where fluid is injected by the jet pump. Consequently, fluid injection by the jet pump does not give rise to a two-phase flow that could lead to undesirable variations of stoichiometry in the main combustion chamber and to undesirable variations in the quantities of the materials that are injected into that chamber.

In the invention, fluid under pressure is injected at high speed into the feed pipe, and thus upstream from the first pump. After being injected, the speed of the injected fluid drops suddenly. Conversely, the drop in the momentum of the fluid is converted into a rise in pressure. This pressure rise serves to compensate the head loss that occurs in the feed pipe.

In the above definition, the presence of a jet pump is specified for only one feed pipe. Nevertheless, both feed pipes are preferably fitted with respective jet pumps, thereby making it possible to benefit from the contribution of the invention both for the fuel and for the oxidizer of the engine.

The engine may have one or two prechambers. If it has two prechambers, they are associated respectively with the fuel and with the oxidizer.

The fluid under pressure is preferably a portion of the fluid delivered by the first pump.

Nevertheless, if a pressure booster is used for compressing the fuel or the oxidizer downstream from said first pump, the stream of fluid under pressure delivered to the jet pump could equally well be taken from a stream of fluid delivered by the pressure booster, and in particular from a delivery orifice of the pressure booster or by being taken from a fluid pipe connected to that orifice.

The pressure booster is generally in the form of a pump having an impeller (or a bladed wheel) that is situated immediately downstream from the main pump and that is arranged on the same shaft as the main pump. The function of the pressure booster is to raise the pressure of a portion of the fuel or oxidizer taken from the main pipe in order to raise this pressure to a value that is sufficient for enabling the fluid that is taken to be injected into the combustion prechamber.

The operation of the jet pump(s) may also be controlled, e.g. by means of a regulator valve arranged in the pipe for feeding this pump (or these pumps) with fluid under pressure. Under such circumstances, the engine also has a regulator valve arranged in the pipe for feeding the jet pump with fluid under pressure, and the opening of the valve can be controlled so as to control pressure at an admission orifice of said first pump.

The structure of the engine of the invention presents the following advantages:
great ease in laying out the engine, since the jet pump is very compact and makes it possible to omit the booster pump that was used in the past;
great simplicity in implementation;
a high degree of robustness in the absence of rotary parts; and
in an engine having a pressure booster, use of the fluid delivered at the outlet from the pressure booster is optimized.

The invention can be well understood and its advantages appear better on reading the following detailed description of embodiments given as non-limiting examples. The description refers to the accompanying drawings, in which:

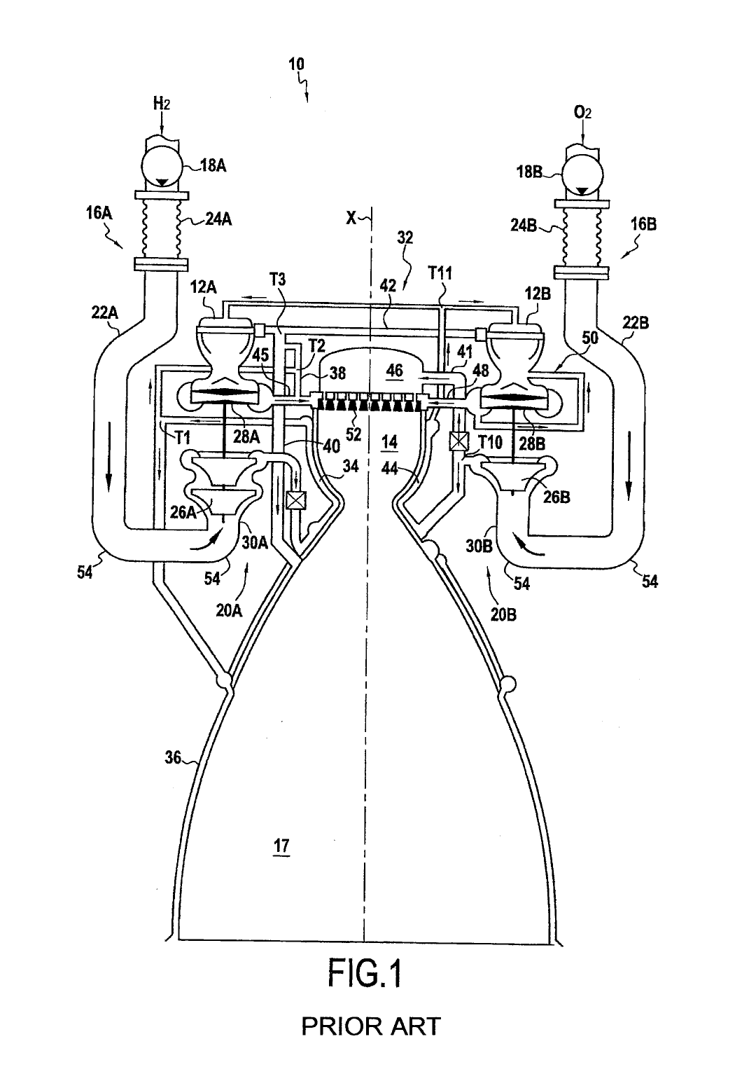

FIG. 1 is a diagrammatic axial section of a prior art rocket engine;

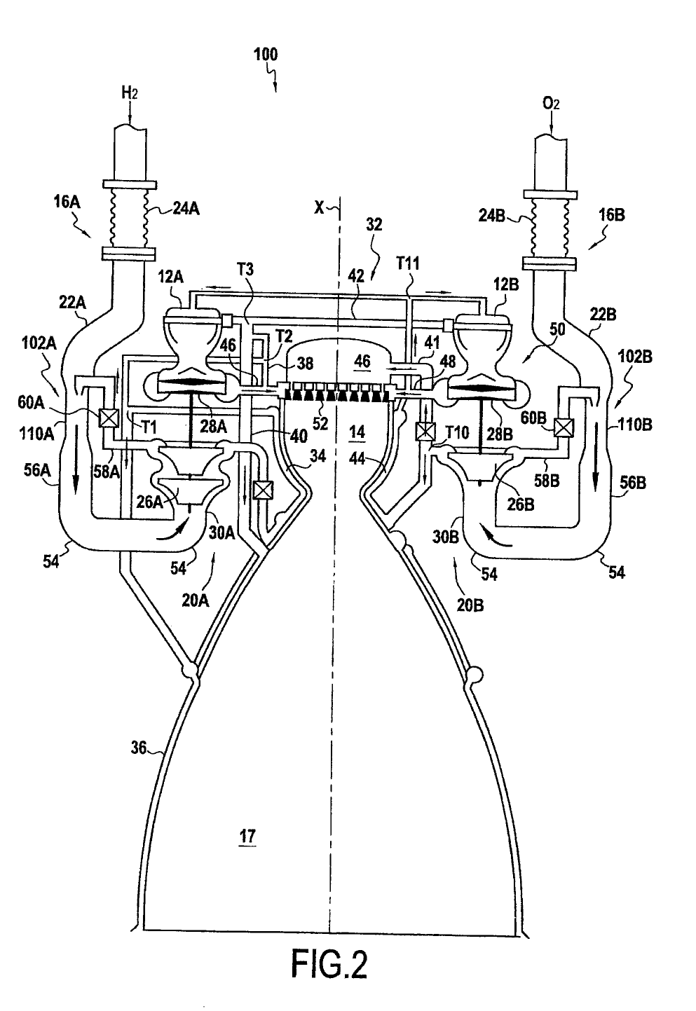

FIG. 2 is a diagrammatic axial section of a rocket engine of the invention;

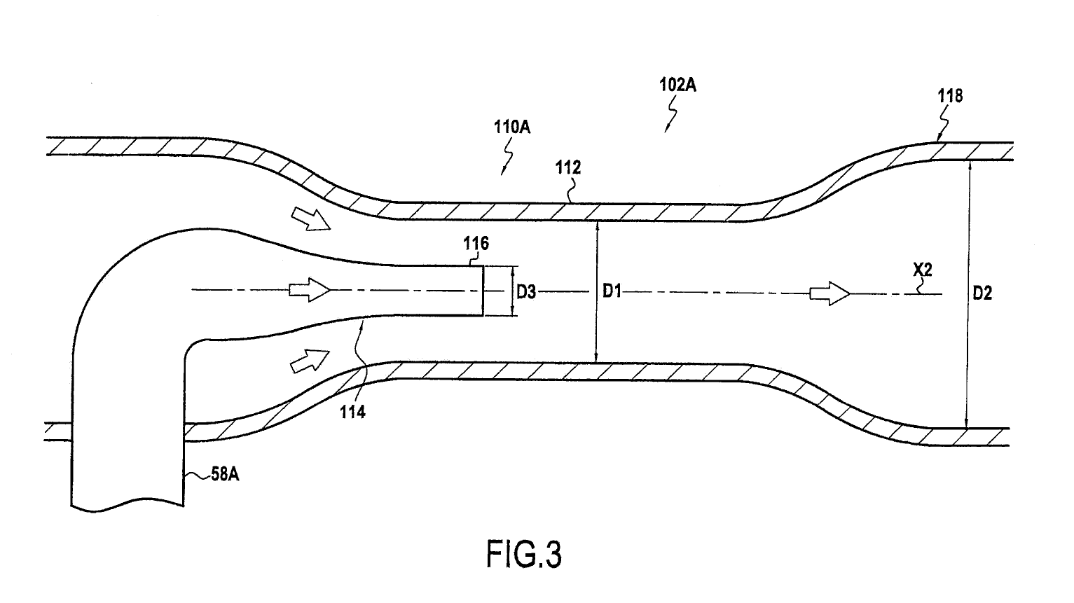

FIG. 3 is a diagrammatic axial section of a jet pump used in the FIG. 2 engine;

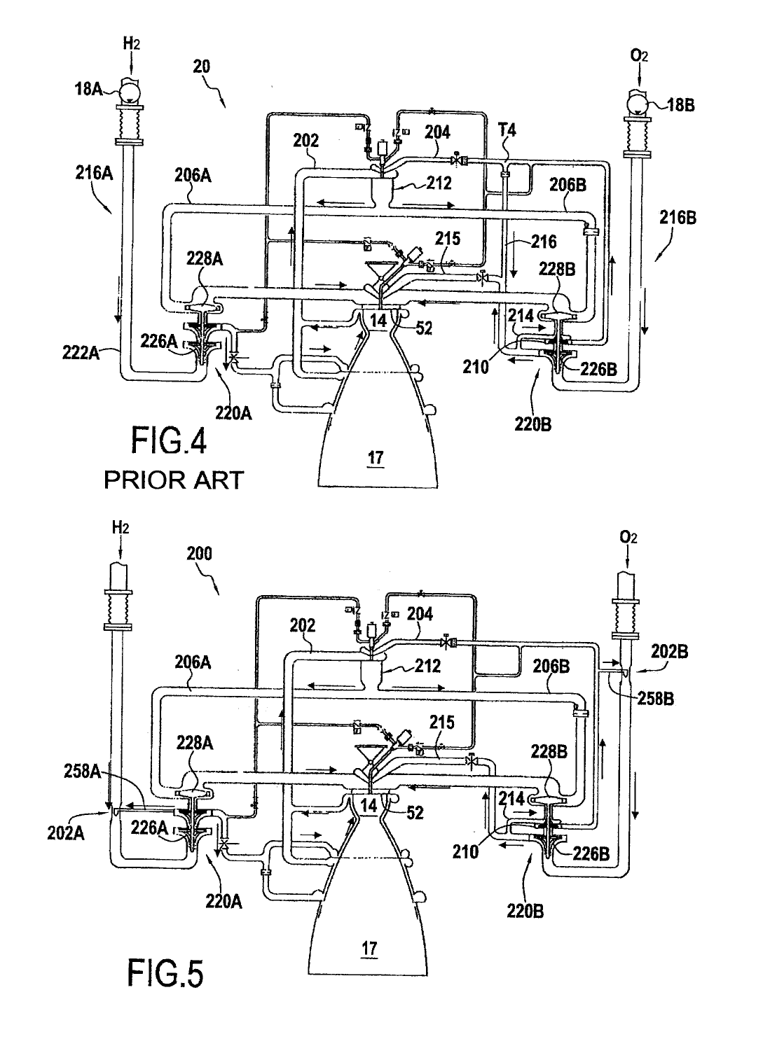

FIG. 4 is a diagrammatic axial section of a prior art rocket engine; and

FIG. 5 is a diagrammatic axial section of a rocket engine of the invention in an embodiment with a pressure booster and a single prechamber.

With reference to FIG. 1, there follows a description of a prior art type of rocket engine 10.

This engine 10 is a staged combustion engine. It sucks in and compresses an oxidizer and a fuel which are burnt and expanded in a main combustion chamber 14. In the example described, the fuel is hydrogen and the oxidizer is oxygen; other fuel/oxidizer pairs could be used in the context of the invention.

The engine 10 has two combustion prechambers 12A and 12B; a main combustion chamber 14; two feed circuits 16A and 16B for feeding the engine respectively with fuel and with oxidizer; a nozzle presenting a diverging cone 17; and two turbopumps 20A and 20B.

Each of the feed circuits 16A and 16B has a booster pump (18A, 18B), a flexible segment (24A, 24B), and a feed pipe (22A, 22B).

The turbopumps 20A and 20B are turbopumps of conventional type respectively for hydrogen and for oxygen. Each of them comprises a pump (one of the pumps 26A, 26B) associated with a turbine (one of the turbines (28A, 28B). The pump 26A is a two-stage pump, whereas the pump 26B has only one stage. The pumps 26A and 26B are arranged at the respective downstream ends 30A and 30B of the feed pipes 22A and 22B. The pumps 26A and 26B serve respectively to pump the fuel and the oxidizer from the tanks (not shown) in which they are stored via the feed pipes and on to the main combustion chamber 14 via a fluid distribution circuit 32.

The engine 10 operates as follows.

The fuel and the oxidizer are pumped from their respective tanks by the booster pumps 18A and 18B; they pass via the flexible segments 24A and 24B and the feed pipes 22A and 22B. They are then pumped from these pipes by the pumps 26A and 26B.

### Fuel Circuit

The pump 26A discharges fluid from the pipe 22A to a fuel regenerator circuit 34. This circuit 34 passes in contact with the combustion chamber 14, thereby cooling the combustion chamber while raising the temperature of the fuel. On leaving the circuit 34, the stream of gas splits at a branch point T1. A first portion of the gas is directed to a circuit 36 for cooling the diverging cone. The other portion of the gas is split once more at a second branch point T2. A first portion of the gas passing via this branch point is injected into the combustion chamber via a pipe 38; a portion is directed to the circuit 36 for cooling the diverging cone via a pipe 40; the remainder is directed by means of a pipe 42 to the two prechambers 12A and 12B via a third branch point T3.

### Oxidizer Circuit

The pump 26B delivers fluid from the pipe 22B to a branch point T10 where the stream of oxidizer is split into two. A first portion is directed to the combustion chamber 14 via a pipe 41. It is injected therefrom into the dome 46 where it is burnt with the hot gas coming from the turbines 28A and 28B.

The second portion of the stream passing via the branch point T10 is directed to an oxidizer regenerator circuit 44 and flows in contact with the main combustion chamber 14. At the outlet from the circuit 44, the stream is split once more at a branch point T11 to feed the two prechambers 12A and 12B with oxidizer.

As mentioned above, respective portions of the fuel and of the oxidizer are taken in the distribution circuit 32 and directed to the prechambers 12A and 12B. The gas produced by the combustion that follows in these prechambers passes through the turbines 28A and 28B. The power transmitted to these turbines by this gas serves to drive the pumps 26A and 26B of the turbopumps 20A and 20B. The hot gas leaving the turbine 28A is injected into the combustion chamber 14 via a pipe 45, mixed with the stream of fuel traveling in the pipe 38. The hot gas leaving the turbine 28B is injected into the combustion chamber 14 via a pipe 48. In both pipes (pipes 45 and 48), the gas coming from the turbines 28A and 28B (and mixed with fuel in the pipe 45) is injected into the combustion chamber 14 via an injection head 52.

The gas is then burnt therein with the oxidizer injected by the pipe 41.

The gas burnt in the combustion chamber 14 is ejected and expanded in the diverging cone 17.

Furthermore, a regulator system 50 serves to deflect a portion of the hot gas leaving the turbine 28B and reinjected into the prechamber 12B upstream from the turbine 28B. This system serves to control the power transmitted by the turbopumps 20A and 20B.

In the engine 10, the hot gas pipes 45 and 48 that serve to convey gas from the turbines 28A and 28B to the injection head 52 into the main chamber constitute the elements that are the most critical. That is why the lengths of these pipes need to be minimized. For this purpose, in order to ensure that the engine is compact, the turbopumps 20A and 20B are arranged in a “pump low” configuration. This enables the turbines 26A and 26B to be brought as close as possible to the injection head 52 (in FIG. 1, the top of the figure corresponds to the vertical direction going upwards from the engine in its operating position).

Nevertheless, arranging the engine 10 with the pumps 26A and 26B at the bottoms of the turbopumps makes it necessary to use bends 54 upstream from the pumps. In the engine 10, the head loss generated by these bends 54 is compensated by the booster pumps 18A and 18B.

FIG. 2 shows an embodiment of the invention that makes it possible to avoid having recourse to booster pumps 18A and 18B.

FIG. 2 shows an engine 100 that is identical to engine 10, except where specified to the contrary. That is why elements that are identical or similar are given the same references.

Compared with the engine 10, the special feature of the engine 100 is that it has two jet pumps 102A and 102B; conversely, it is not designed to operate with booster pumps such as the pumps 18A and 18B of the engine 10. The engine 100 can thus operate with fuel and oxidizer coming directly from their respective tanks, without any need to pass via booster pumps.

The jet pumps 102A and 102B are arranged upstream from the bends 54 in the segments 56A and 56B of the pipes 22A and 22B that are parallel to the axis X of the engine 100.

They are fed with gas by feed pipes 58A and 58B, which take a portion of the gas delivered from the delivery orifices of the pumps 26A and 26B.

The proposed solution thus consists in the distribution circuit being arranged in such a manner as to direct a portion of fluid flowing in the main feed pipes downstream from the pumps 26A and 26B that have the effect of raising the pressure of the fluid, so as to feed the jet pumps situated upstream from the bends 54 and thus from the pumps 26A and 26B. (In another embodiment that is described below, the fluid used for feeding the jet pumps and the fluid under pressure coming from one of the main pipes is pressurized by a pressure booster used for feeding the prechamber with fuel or oxidizer.)

The operation of the jet pumps 102A and 102B is shown in FIG. 3 which is an axial section of the jet pump 102A (the pump 102B being similar).

The pump 102A has a body constituted by a segment 110A of the pipe 22A. This segment 110A presents a portion 112 of diameter D1 that is smaller than the diameter D2 of the segment 56A, and which is known as a “mixer” for reasons that are described in detail below.

The pump 102A also has an injector 114. The injector is constituted by the downstream end of the pipe 58A. The injector 114 is in the form of a pipe bend that penetrates into the pipe 22A a short distance upstream from the mixer 112.

The end 116 of the injector 114 is thus in the form of a segment of tube on the axis X2 of the mixer 112, which tube has a diameter D3 that is considerably smaller than the diameter D1 of the mixer 112. For example, the diameter D3 is one-third of D2.

The high-pressure fluid delivered by the pump 26A into the pipe 58A accelerates as it passes through the injector 114. It is then injected into the feed pipe 22A at the upstream portion of the mixer 112 going towards the admission orifice of the pump 26A (downwards). In the mixer 112, the fluid injected by the injector 114 and the fuel circulated in the feed pipe 22A mix together.

The speed in the main pipe 22A is particularly high through the mixer 112 because of its small diameter. In contrast, downstream from the mixer 112, the speed of the fluid decreases; a pressure higher than the pressure upstream from the jet pump 102A becomes established progressively in a flared portion 118 referred to as a diffuser.

By means of this, the effect of the jet pump injecting fluid and entraining the fluid already in the pipe 22A is to increase the pressure in that fluid downstream from the pump.

The pressure increase that results from the action of the pump 102A is regulated by modulating the rate at which fluid is injected by the injector 114. This regulation is performed by controlling a regulator valve 60A arranged in the pipe 58A for feeding hydrogen to the jet pump 102A (or correspondingly 60B in the oxygen feed pipe) by means of a control unit that is not shown.

FIG. 4 shows a prior art rocket engine 20. Its arrangement and operation are analogous to those of the above-described engine 10, and they are therefore not described again in detail.

The engine 20 is identical to the engine 10, except where specified to the contrary. That is why elements that are identical or similar have the same references.

The special features of the engine 20 are as follows.

Firstly, the engine 20 has only a single combustion prechamber 212. Instead of having two prechambers arranged respectively in alignment with each of the two turbopumps 20A and 20B, the engine 20 has a central prechamber 212.

It is fed with hydrogen and oxygen respectively by two pipes 202 and 204.

The combustion gas under pressure leaving the prechamber 212 is split into two streams that are directed via pipes 206A and 206B to the turbines 228A and 228B of the two turbopumps, which they drive in rotation.

This gas is then directed to the combustion chamber where it ends up by being burnt.

In order to improve the efficiency of the engine 20, a pressure booster 210 is provided in the oxygen transfer circuit. This pressure booster serves to pressurize the oxygen in the pipe 204. The pressure at the delivery orifice of the pressure booster 210 is considerably higher than the pressure at the delivery orifice of the pump 226B; typically, this pressure is 350 bar, whereas the pressure at the delivery orifice of the pump 226B may be in the region of 200 bar. This pressure is determined so as to enable the prechamber 212 to be suitably fed with oxygen.

The oxygen delivered by the pump 226B is directed to the combustion chamber via a pipe 215. A portion of the oxygen passing via this pipe is taken via a pipe 214; it then passes through the pressure booster 210.

The pressure booster 210 is driven by the turbine 228B of the pump 220B; the turbine 228B, the pressure booster 210, and the pump 226B thus share a common shaft.

Downstream from the pressure booster 210, the pipe 214 splits into two at a branch point T4: a major portion of the oxygen then joins the pipe 215 via a bypass connection 216; and the remaining minor fraction of oxygen is directed by the pipe 204 to the prechamber 212 in order to feed it with oxygen.

FIG. 5 shows a rocket engine 200. This engine is derived from the engine 20 that has been modified so as to incorporate the invention. The engine 200 is identical to the engine 20, except when specified to the contrary. That is why elements that are identical or similar have the same references.

In the engine 200, two jet pumps 202A and 202B are arranged in the oxygen and hydrogen feed pipes 222A and 222B. These jet pumps 202A and 202B are analogues in operation and structure to the pumps 102A and 102B as described above. In addition, they produce the same effect, i.e. they raise the feed pressure of the pumps 226A and 226B.

The jet pump 202A is fed with oxygen under pressure by a feed pipe 258A, which takes oxygen from the delivery orifice of the pump 226A, in similar manner to the pump 102A.

The jet pump 202B is fed with oxygen under pressure by a feed pipe 258B, which takes oxygen from the portion of the pipe 214 situated downstream from the delivery orifice of the pressure booster 210. As a result, while the engine 200 is in operation, the oxygen delivered at high pressure by the pressure booster 210 entrains the oxygen flowing in the feed pipe 222B, thereby advantageously raising the pressure at the admission orifice of the pump 226B.

1-8. (canceled)

9. A rocket engine having a combustion prechamber; a main combustion chamber ; two feed pipes for feeding the engine respectively with fuel and with oxidizer; and two turbopumps, each having a pump associated with a turbine, said pumps being arranged at respective downstream ends of the feed pipes and being suitable for pumping the fuel and the oxidizer from the feed pumps to the main combustion chamber via a fluid distribution circuit;
the distribution circuit being suitable for directing at least a portion of the fuel and of the oxidizer to the prechamber in order to be burnt therein, and for directing the hot gas as produced in that way from the prechamber to the combustion chamber while driving at least one turbine of the turbopumps;
wherein a jet pump is arranged in at least a first feed pipe feeding a first of the pumps,
the distribution circuit is suitable for putting under pressure a portion of the fluid flowing in the first feed pipe and directing this portion of fluid to the jet pump, and
the jet pump is suitable for injecting the portion of fluid in such a manner as to entrain the fluid flowing in the first feed pipe towards an admission orifice of the first pump.

10. An engine according to claim 9, wherein the distribution circuit is arranged in such a manner that the fluid injected by the jet pump does not include combustion gas.

11. An engine according to claim 9, wherein the jet pump injects only the fluid portion into the first feed pipe.

12. An engine according to claim 9, wherein the distribution circuit is arranged in such a manner that the fluid injected by the jet pump and the fluid flowing in the first feed pump at the fluid injection point by the jet pump are in the liquid phase.

13. An engine according to claim 9, wherein the fluid portion is a portion of the fluid delivered by the first pump.

14. An engine according to claim 9, further including a pressure booster suitable for compressing the fuel or the oxidizer upstream from the first pump, and wherein the fluid portion is constituted by a fluid stream delivered by the pressure booster.

15. An engine according to claim 9, wherein the jet pump is arranged on a segment of the first feed pipe that is parallel to an axis of the engine.

16. An engine according to claim 9, further including a regulator valve arranged in the feed pipe for feeding fluid under pressure to the jet pump and of opening that can be controlled in such a manner as to control pressure at an admission orifice of the first pump.
